(19) United States
(12) Patent Application Publication
(10) Pub. No.: US 2013/0040777 A1
(43) Pub. Date: Feb. 14, 2013

(54) MULTI-STAGE PLANETARY GEAR TRAIN

(71) Applicants: Jörg Gassmann, Dresden (DE); Thomas Müller, Dresden (DE); Ronny Keil, Chemnitz (DE)

(72) Inventors: Jörg Gassmann, Dresden (DE); Thomas Müller, Dresden (DE); Ronny Keil, Chemnitz (DE)

(73) Assignee: Johnson Electric Dresden GmbH, Dresden (DE)

(21) Appl. No.: 13/515,568

(22) PCT Filed: Nov. 4, 2010
(86) PCT No.: PCT/DE10/01292

§ 371 Date: Oct. 15, 2012

(30) Foreign Application Priority Data
Nov. 13, 2009 (DE) 10 2009 052 898.9

(51) Int. Cl. F16H 1/46

(52) U.S. Cl. 475/337

(57) ABSTRACT

A multi-stage planetary gear train, with several annular segments arranged between the adapter plates of the motor and of the gear head, each annular segment has a planetary gear set comprising a sun gear, several planet gears carried by a planet carrier, and a ring gear having inner teeth. Adjacent annular segments are coupled to each other and the outer segments are coupled to the respective adapter plates. The annular segments and the corresponding adapter plates in the region of the adjacent end faces thereof form a coupling area each, and the segments each comprise at least one engaging element on one end face thereof and at least one complementary receiving element on the opposite end face thereof, wherein the engaging element of a segment engages with the receiving element of an adjacent segment or of an adapter plate in a form-fit or force-closed manner in the assembled state.

The invention relates to a multi-stage planetary gear train, at least comprising several annular segments arranged one behind the other in the axial direction between the adapter plates of the motor and of the gear head, each annular segment having a planetary gear set comprising a sun gear, several planet gears carried by a planet carrier, and a ring gear having inner teeth, wherein adjacent annular segments are coupled to each other and the outer segments are coupled to the respective adapter plates.

A planetary gear train is a special configuration of a compact gear train having shafts arranged coaxially to each other, as a rule.

The fundamental design comprises a gear set including, from inside to the outside, a sun gear, several planet gears carried by a planet carrier, and a ring gear having inner teeth.

Not only the above mentioned single planetary gear set, however, is known as a planetary gear train but also all combinations, based on this fundamental design, of several planetary gear sets switched one after the other. In this way, high gear ratio reductions can be obtained, wherein the total speed reduction results from the respective number of steps and each individual reduction. In this design the planetary gear train is formed of several annular segments arranged one behind the other in the axial direction, with each individual segment comprising a ring gear and a planetary gear set. In assembled state the respective ring gears of the individual segments complete to form a ring gear.

In prior art DE 41 05 907 A1 discloses a multi-stage planetary gear train. The planetary gear train comprises two or more installation kits each having an outer ring gear, planet gears and sun gear. This invention is characterized in that the installation kits complete to a stepped gear box through adapter rings connecting the ring gears to each other, each ring gear optionally providable with an own rotating outer envelope to form an annular channel for guiding a tempering medium.

DE 197 38 429 A1 describes a gear train with a high reduction ratio, particularly for shutters, awnings, curtains, closing elements and the like. The gear train comprises a drive shaft and an output shaft, two interposed gear stages and a gearbox casing. It is characteristic of this invention that the two gear stages are supported in separate casing modules, mounted to each other aligned.

Further, from DE 15 50 761 A and DE 19 19 825 U planetary gear trains are known having several annular segments axially placed one to the other.

It is inherent to all above mentioned solutions that additional fastening devices, usually bolts, are used to join the individual annular segments together.

This jointing technology requires relatively large bolts because of the high forces to be absorbed, making more difficult to miniaturise the general design. In addition, bolts cannot ensure that the different components are exactly positioned relative to each other; additional reference elements such as alignment pins are needed. Moreover, fastening using bolts is difficult in gearboxes with the ring gear segments made of plastics, as threaded holes of small diameters have no sufficient bearing capacity, not allowing to create the necessary fastening forces.

This invention aims at proposing a multi-stage planetary gear train with the individual annular segments accurately positioned relative to each other and permanently connected to each other.

According to the concept of the invention the multi-stage planetary gear train includes at least several annular segments arranged one behind the other in the axial direction between the adapter plates of the motor and of the gear head, each annular segment having a planetary gear set comprising a sun gear, several planet gears carried by a planet carrier, and a ring gear having inner teeth, wherein adjacent annular segments are coupled to each other and the outer segments are coupled to the respective adapter plates. The invention is characterized in that the annular segments and the corresponding adapter plates in the region of the adjacent end faces thereof form a coupling area each. For that reason each segment comprises at least one engaging element on one end face thereof and at least one complementary receiving element on the opposite end face thereof, wherein in the assembled state the engaging element of a segment engages with the receiving element of an adjacent segment or of an adapter plate by form closure or force closure.

The receiving element is preferably established as a hole, the engaging element as complementary sleeve.

In a particularly advantageous embodiment of the invention the engaging element is designed as a sleeve distally tapered or stepped in cross-section, the circumferential surface of the sleeve interrupted by a slit extending in the direction of the longitudinal axis of the sleeve.

According to the invention, sufficiently high security against deliberate or unintentional loosening of the single segments is ensured by that an alignment pin is provided with an outer contour established partially fitting to the inner contour of the sleeve, the alignment pin, after the engaging element has been inserted into the receiving element, drivable in the engaging element that is designed as slitted sleeve so that the engaging element is referenced and tensioned against the receiving element. Due to the engaging element designed stepped in cross-section and established as sleeve the alignment pin can easily be inserted into the engaging element, then expanding the engaging element of this segment in the region of the tapered cross-section so that the head of the engaging element, according to the invention, can clamp in the receiving element. Here a form closure and/or force closure then develop. The inner contour is designed such that individual segments when the alignment pin is driven in, form a press fit and/or a form closure that then cause the engaging element to deform and be tensioned against the receiving element.

Extensive test series have shown that the alignment pin can ensure that both the positioning and the tensioning of the single annular segments are optimally obtained.

The slit placed in the circumferential surface and a cleared region in the circumferential surface prevent the gear geometry of the adjacent segment from being deformed due to tensioning by the alignment pin.

Substituting the clamping or tensioning connection according to the invention for the threaded connections of prior art enables the production costs of the multi-stage planetary gear train to be significantly reduced and distinctly higher manufacture accuracy to be reached.

The outer surface of the engaging element and the inner surface of the receiving element each are established smooth, or provided with a structure or geometry enabling or at least promoting both coupling partners hooking together. In terms of the invention, structure or geometry is the surface condition and surface geometry.

In practice it has shown to be particularly advantageous that sufficiently high holding forces between the annular segments to be coupled to each other can be obtained, if for optimum force dissipation each annular segment is provided with several engaging elements on its first end face and with the same number of complementary receiving elements on its opposite other end face. In cooperation with the alignment pin, after driven in extending within the sleeve-like engaging element, the planetary gear train according to the invention can be easily and quickly assembled.

The significant advantages and features of the invention over prior art essentially are:
simple, cost-effective connection technology, well suited for gear trains made of plastics, also easily mountable automatically;
conventional threaded connections are replaced with clamping connections enabling much higher precision and extreme miniaturisation;
coupling of the single annular segments occurs by a combination of dowelling using an alignment pin and tensioning of the engaging element to the receiving element based on deformation of the sleeve-like engaging element established slitted;
the slit placed in the circumferential surface and an additional cleared region ensure that the gear geometry of the adjacent segment is not deformed during tensioning by the alignment pin.

The objects and advantages of the invention will become apparent upon reading the following detailed description of the here preferred, not limiting exemplary embodiments of the invention taken in conjunction with the accompanying drawings in which is shown by:

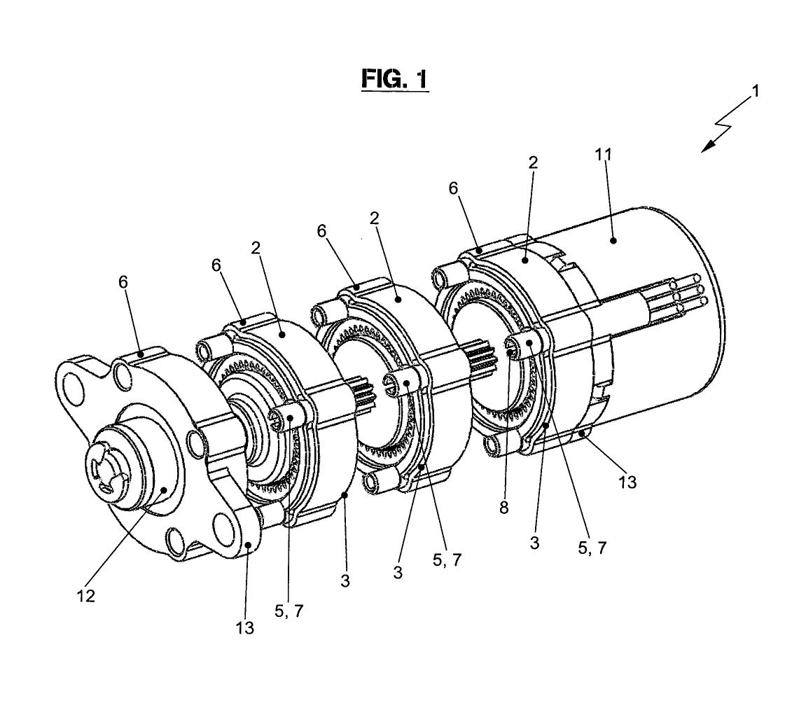

FIG. 1 an explosive view of the planetary gear train with several segments immediately before assembly;

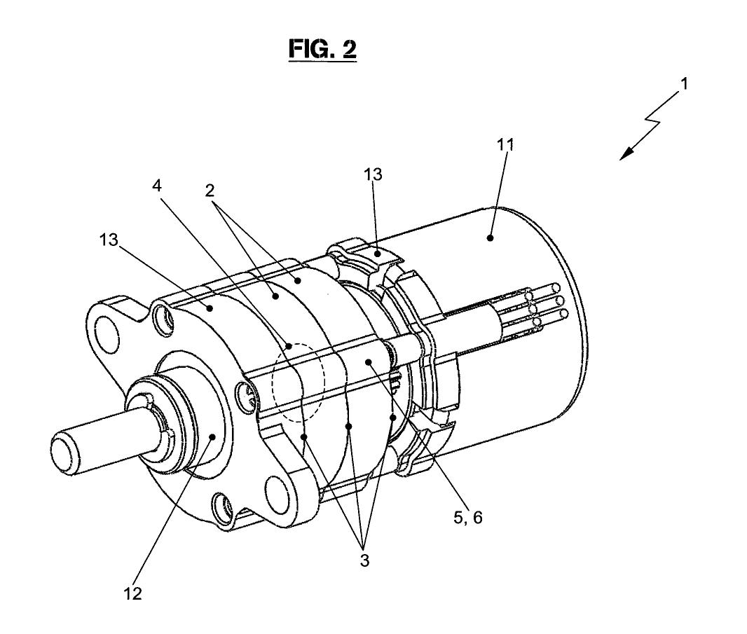

FIG. 2 an explosive view of the planetary gear train with several segments coupled to each other, with one segment faded out for improved clarity;

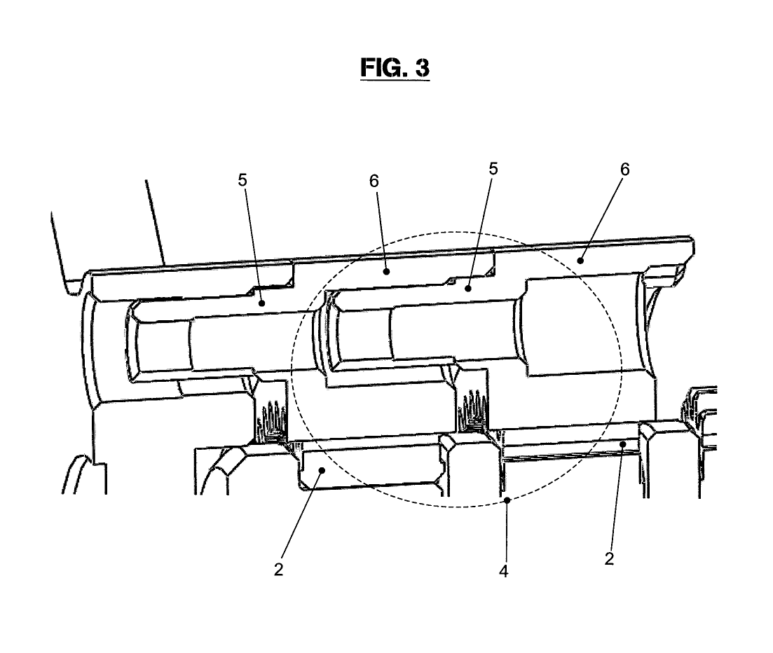

FIG. 3 a first detail representation of the coupling area of two segments coupled to each other, without alignment pin; and

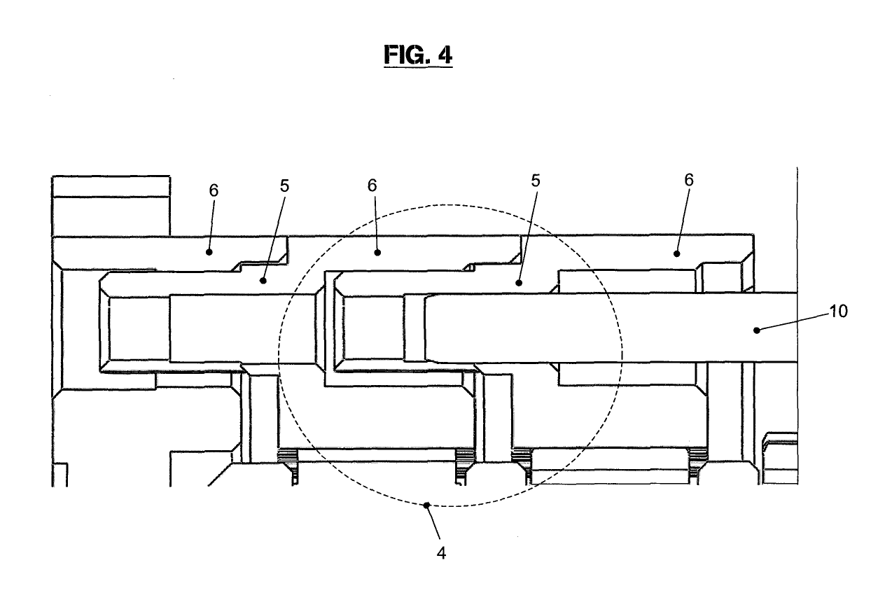

FIG. 4 a second detail representation of the coupling area of two segments coupled to each other with alignment pin.

FIG. 1 illustrates an explosive view of a planetary gear train 1 according to the invention with several uncoupled annular segments 2 immediately before assembly. All segments 2, each—here indicated only—including a planetary gear set comprising a sun gear, several planet gears carried by a planet carrier, and a ring gear having inner teeth, are arranged between the adapter plates 13 of the motor 11 and of the gear head 12 with the output end bearing one behind the other in the axial direction. The invention does not teach any design limitation concerning the design of the gear head 12 and the accompanying adapter plate 13. Therefore, the adapter plate 13 and the gear head 12 can be manufactured, or established, in one part or separately.

To FIG. 2, in assembled state adjacent annular segments 2 and the outer segments 2 with the respective adapter plates 13 of the motor 11 and of the gear head 12 are coupled to each other to establish a complete multi-stage planetary gear train 1. For improved clarity one segment 2 is faded out. The annular segments 2 in the region of adjacent faces 3 thereof form a coupling area 4 in each case, see FIGS. 3 and 4. In the example shown, the segments 2 and the adapter plates 13 are provided with four engaging elements 5 on one of the faces 3 thereof and with four complementary receiving elements 6 on the opposite faces 3 thereof. In assembled state the engaging elements 5 of a segment 2 engage in form-closed manner with the receiving elements 6 of an adjacent segment 2 or of an adapter plate 13.

A first detail representation of the coupling area 4 of segments 2 coupled to each other is shown in FIG. 3. That region is understood as coupling area 4 of the segments 2 or of the adapter plates 13, where the directly opposing faces 3 of two adjacent segments 2 or of the adapter plate 13 contact each other. It is seen that the left segment 2 shows a receiving element 6 established as hole, the right segment 2 a complementary sleeve-like engaging element 5. The engaging element 5 is stepped in its cross-section in direction of the longitudinal axis thereof, with zones of different cross-sections establishing in the example shown.

FIG. 4 shows a second detail representation of the coupling area 4 of two segments 2 coupled to each other. The connection, or coupling, respectively, of two adjacent segments 2 or adapter plate 13 is made with help of the engaging elements 5 and the receiving elements 6 in cooperation with the alignment pin 10. According to the invention the outer contour of the alignment pin 10 is partially fitting to the inner contour of the engaging element 5, the alignment pin 10 after inserting the engaging element 5 into the receiving element 6 being driven into the engaging element 5 established as slitted sleeve, see FIG. 1, so that the engaging element 5 is referenced and tensioned against the receiving element 6. The slit 8 placed in the circumferential surface 7, of the engaging element 5, see FIG. 1, is established wedge-like with a cross-section expanding in the direction of the inner surface of the engaging element 5 so that circumferential surface flanks 9 develop. The circumferential surface flanks 9, or the cleared region, respectively, prevents the gear geometry of the subsequent segment 2 from deforming upon tensioning by the alignment pin 10.

### NOMENCLATURE

1 planetary gear train
2 segment
3 face
4 coupling area
5 engaging element
6 receiving element
7 circumferential surface
8 slit
9 circumferential surface flank
10 alignment pin
11 motor
12 gear head
13 adapter plate

1. (canceled)

2. (canceled)

3. (canceled)

4. (canceled)

5. (canceled)

6. (canceled)

7. (canceled)

8. A multi-stage planetary gear train (1), comprising
a plurality of annular segments (2) axially arranged one behind the other between an adapter plates (13) of a motor (11) and a gear head (12),
each annular segment having a planetary gear set comprising
a sun gear,
a plurality of planet gears carried by a planet carrier, and a ring gear having inner teeth,
wherein adjacent annular segments (2) are coupled to each other and the outer segments (2) are coupled to the respective adapter plates (13), and
wherein the annular segments (2) and the corresponding adapter plates (13) in the region of adjacent end faces (3) thereof form a coupling area (4) each, and the annular segments (2) each comprise at least one engaging element (5) on one end face (3) thereof designed as a sleeve which is distally tapered or stepped in cross-section, with the circumferential surface (7) of the sleeve interrupted by a slit (8) extending in direction of the longitudinal axis of a circumferential surface (7) and at least one complementary receiving element (6) on the opposite end face (3) thereof established as a hole, wherein the at least one engaging element (5) engages with a receiving element (6) of an adjacent segment (2) or of an adapter plate (13) in a form-fit or force-closed manner in the assembled state.

9. The multi-stage planetary gear train (1) according to claim 1, further comprising an alignment pin (10) with an outer contour established fitting to the inner contour of the sleeve, the alignment pin (10), after insertion of the at least one engaging element (5) into the at least one complementary receiving element (6), being drivable in the engaging element (5) which is formed as a slitted sleeve so that the at least one engaging element (5) is referenced and tensioned against the at least one complementary receiving element (6).

10. The multi-stage planetary gear train (1) according to claim 2, wherein , due to the sleeve-like engaging element (5) established stepped in its cross-section zones of different fit character, form to receive the alignment pin (10).

11. The multi-stage planetary gear train (1) according to claim 1, wherein the at least one engaging element (5) has each an outer surface, the inner surface of the receiving element (6) each are established smooth or provided with a structure or geometry enabling or at least promoting both coupling partners hooking together.

12. The multi-stage planetary gear train (1) according to claim 1, wherein, for optimum force dissipation each annular segment (3) is provided with several engaging elements (5) on one of its faces (3) and with the same number of complementary receiving elements (6) on its opposite other face (3).

13. The multi-stage planetary gear train (1) according to claim 10, wherein the fit character is a press fit.
